(19) United States
(12) Patent Application Publication
(10) Pub. No.: US 2025/0247170 A1
(43) Pub. Date: Jul. 31, 2025

(54) REPORTING PASSIVE INTERNET OF THINGS (IoT) DEVICE SIGNAL DECODING TIMES

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Zhikun WU, Beijing (CN); Yuchul KIM, San Diego, CA (US); Linhai HE, San Diego, CA (US); Huilin XU, Temecula, CA (US)

(21) Appl. No.: 18/856,009

(22) PCT Filed: Jun. 23, 2022
(86) PCT No.: PCT/CN2022/100645

§ 371 Date: Oct. 10, 2024

(51) Int. Cl. H04L 1/1812; H04W 72/21; H04W 92/18

(52) U.S. Cl. CPC H04L 1/1812; H04W 72/21; H04W 92/18

(57) ABSTRACT

A method for wireless communication performed at a user equipment (UE) includes transmitting, to a network node, a decoding time message indicating: a first amount of time for decoding, by the UE, first hybrid automatic repeat request (HARQ) feedback associated with a first command transmitted from the UE to a passive Internet of things (IoT) device; and a second amount of time for decoding, by the UE, first passive IoT data received from the passive IoT device based on the UE transmitting the first command. The method also includes receiving a grant for communicating with the passive IoT device based on transmitting the decoding time message. The method further includes communicating with the passive IoT device based on receiving the grant.

### FIELD OF THE DISCLOSURE

The present disclosure relates generally to wireless communications, and more specifically to decoding passive Internet of things (IoT) device signals and reporting passive IoT signal decoding times.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example, bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation.

Passive Internet of things (IoT) devices, such as radio frequency identifier (RFID) tags, may communicate with other devices via passive communication technologies. Backscatter communication is an example of a passive communication technology. The use of passive communication technologies may reduce an amount of power consumed by passive IoT devices, and may reduce costs associated with manufacturing passive IoT devices. Conventional passive IoT devices, such as conventional ultra-high frequency (UHF) RFID devices, may operate within an industrial, scientific, and medical (ISM) band. Such conventional passive IoT devices are not compatible with wireless communication systems that operate within a licensed band, such as new radio (NR) systems.

### SUMMARY

In one aspect of the present disclosure, a method for wireless communication performed at a UE includes transmitting, to a network node, a decoding time message indicating: a first amount of time for decoding, by the UE, first hybrid automatic repeat request (HARQ) feedback associated with a first command transmitted from the UE to a passive Internet of Things (IoT) device; and a second amount of time for decoding, by the UE, first passive IoT data received from the passive IoT device based on the UE transmitting the first command. The method also includes receiving a grant for communicating with the passive IoT device based on transmitting the decoding time message. The method further includes communicating with the passive IoT device based on receiving the grant.

Another aspect of the present disclosure is directed to an apparatus including means for transmitting, to a network node, a decoding time message indicating: a first amount of time for decoding, by the UE, first hybrid HARQ feedback associated with a first command transmitted from the UE to a passive IoT device; and a second amount of time for decoding, by the UE, first passive IoT data received from the passive IoT device based on the UE transmitting the first command. The apparatus also includes means for receiving a grant for communicating with the passive IoT device based on transmitting the decoding time message. The apparatus further includes means for communicating with the passive IoT device based on receiving the grant.

In another aspect of the present disclosure, a non-transitory computer-readable medium with non-transitory program code recorded thereon is disclosed. The program code is executed by a processor and includes program code to transmit, to a network node, a decoding time message indicating: a first amount of time for decoding, by the UE, first HARQ feedback associated with a first command transmitted from the UE to a passive IoT device; and a second amount of time for decoding, by the UE, first passive IoT data received from the passive IoT device based on the UE transmitting the first command. The program code also includes program code to receive a grant for communicating with the passive IoT device based on transmitting the decoding time message. The program code further includes program code to communicate with the passive IoT device based on receiving the grant.

Another aspect of the present disclosure is directed to an apparatus for wireless communications at a UE. The apparatus includes a processor; and a memory coupled with the processor and storing instructions operable, when executed by the processor, to cause the apparatus to transmit, to a network node, a decoding time message indicating: a first amount of time for decoding, by the UE, first HARQ feedback associated with a first command transmitted from the UE to a passive IoT device; and a second amount of time for decoding, by the UE, first passive IoT data received from the passive IoT device based on the UE transmitting the first command. Execution of the instructions also cause the apparatus to receive a grant for communicating with the passive IoT device based on transmitting the decoding time message. Execution of the instructions further cause the apparatus to communicate with the passive IoT device based on receiving the grant.

In one aspect of the present disclosure, a method for wireless communication performed at a UE includes receiving, from a reader UE, a message indicating: a first amount of time for decoding, by the reader UE, first HARQ feedback associated with a first command transmitted from the source UE to a passive IoT device; and a second amount of time for decoding, by the reader UE, first passive IoT data received from the passive IoT device based on the source UE transmitting the first command to the passive IoT device. The method further includes transmitting, to a network node, a decoding time message indicating the first amount of time and the second amount of time. The method still further includes receiving, from the network node, a group of grants for communicating with the passive IoT device based on transmitting the decoding time message. The method also includes communicating with the passive IoT device based on receiving the group of grants.

Another aspect of the present disclosure is directed to an apparatus including means for receiving, from a reader UE, a message indicating: a first amount of time for decoding, by the reader UE, first HARQ feedback associated with a first command transmitted from the source UE to a passive IoT device; and a second amount of time for decoding, by the reader UE, first passive IoT data received from the passive IoT device based on the source UE transmitting the first command to the passive IoT device. The apparatus further includes means for transmitting, to a network node, a decoding time message indicating the first amount of time and the second amount of time. The apparatus still further includes means for receiving, from the network node, a group of grants for communicating with the passive IoT device based on transmitting the decoding time message. The apparatus also includes means for communicating with the passive IoT device based on receiving the group of grants.

In another aspect of the present disclosure, a non-transitory computer-readable medium with non-transitory program code recorded thereon is disclosed. The program code is executed by a processor and includes program code to receive, from a reader UE, a message indicating: a first amount of time for decoding, by the reader UE, first HARQ feedback associated with a first command transmitted from the source UE to a passive IoT device; and a second amount of time for decoding, by the reader UE, first passive IoT data received from the passive IoT device based on the source UE transmitting the first command to the passive IoT device. The program code further includes program code to transmit, to a network node, a decoding time message indicating the first amount of time and the second amount of time. The program code still further includes program code to receive, from the network node, a group of grants for communicating with the passive IoT device based on transmitting the decoding time message. The program code also includes program code to communicate with the passive IoT device based on receiving the group of grants.

Another aspect of the present disclosure is directed to an apparatus for wireless communications at a UE. The apparatus includes a processor; and a memory coupled with the processor and storing instructions operable, when executed by the processor, to cause the apparatus to receive, from a reader UE, a message indicating: a first amount of time for decoding, by the reader UE, first HARQ feedback associated with a first command transmitted from the source UE to a passive IoT device; and a second amount of time for decoding, by the reader UE, first passive IoT data received from the passive IoT device based on the source UE transmitting the first command to the passive IoT device. Execution of the instructions also cause the apparatus to transmit, to a network node, a decoding time message indicating the first amount of time and the second amount of time. Execution of the instructions further cause the apparatus to receive, from the network node, a group of grants for communicating with the passive IoT device based on transmitting the decoding time message. Execution of the instructions also cause the apparatus to communicate with the passive IoT device based on receiving the group of grants.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4 is a block diagram illustrating an example of a passive Internet of things (IoT) system, in accordance with various aspects of the present disclosure.

FIG. 5A is a diagram illustrating an example of a bi-static backscatter communication system, in accordance with various aspects of the present disclosure.

FIG. 5B is a diagram illustrating an example of a mono-static backscatter communication system, in accordance with various aspects of the present disclosure.

FIG. 6 is a timing diagram illustrating an example of a source UE in a bi-static system indicating one or more decoding times to a network node, in accordance with various aspects of the present disclosure.

FIG. 7 is a timing diagram illustrating an example of a UE in a mono-static system indicating one or more decoding times to a network node, in accordance with various aspects of the present disclosure.

FIG. 8 is a block diagram illustrating an example wireless communication device that supports communicating with a passive IoT device, in accordance with some aspects of the present disclosure.

FIG. 9 is a flow diagram illustrating an example process performed, for example, by a UE, in accordance with various aspects of the present disclosure.

FIG. 10 is a flow diagram illustrating an example process performed, for example, by a source UE, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Passive Internet of things (IoT) devices, such as radio frequency identifier (RFID) tags, may communicate with other devices via passive communication technologies. Backscatter communication is an example of a passive communication technology. The use of passive communication technologies may reduce an amount of power consumed by passive IoT devices, and may reduce costs associated with manufacturing passive IoT devices. Conventional passive IoT devices, such as conventional ultra-high frequency (UHF) RFID devices, may operate within an industrial, scientific, and medical (ISM) band. Such conventional passive IoT devices are not compatible with wireless communication systems that operate within a licensed band, such as new radio (NR) systems.

When operating within the licensed band, a passive IoT device may communicate with one or more user equipment (UEs) via a sidelink interface, a radio access interface (for example, a Uu interface), or another type of wireless communication interface. The one or more UEs may include a reader UE and a source UE. In some examples, the source UE and the reader UE are different UEs. A bi-static system is an example of a system in which the source UE and the reader UE are different UEs. In some other examples, the source UE and the reader UE are the same UE. A mono-static system is an example of a system in which the source UE and the reader UE are the same UE. In both a mono-static system and a bi-static system, the reader UE and source UE may communicate with the passive IoT device based on one or more grants, such as a dynamic grant, configured by a network node. In some examples, the source UE may transmit commands to the passive IoT device based on receiving a grant from the network node. Additionally, or alternatively, the reader UE may receive data from the passive IoT device, via a backscattered signal, based on receiving a grant from the network node. In some examples, the network node configures the one or more grants based on one or more decoding times associated with the reader UE.

Aspects of the present disclosure generally relate to receiving, from a network node, one or more grants for communicating with a passive IoT device based on indicating an amount of time for decoding each signal of one or more signals received from a passive IoT device. Various aspects of the present disclosure more specifically relate to receiving one or more signals from a passive IoT device, decoding the one or more signals received from the passive IoT device, and reporting, to a network node, an amount of time for decoding the one or more signals received from the passive IoT device. In particular, a source UE may determine a first decoding time corresponding to an amount of time for decoding, by a reader UE, hybrid automatic repeat request (HARQ) feedback associated with a command transmitted from the source UE to the passive IoT device. The HARQ feedback may indicate an acknowledgment (ACK) or a negative acknowledgment (NACK) indicating whether the passive IoT device decoded the command (for example, information) transmitted from the source UE. In a bi-static system, the source UE receives a message, from the reader UE, indicating the first decoding time. In a mono-static system, the source UE and the reader UE are the same UE. Therefore, in the mono-static system the same UE transmits the command to the passive IoT device and decodes the HARQ feedback received from the passive IoT device based on transmitting the command. Additionally, in some examples, the passive IoT device may transmit passive IoT data via the backscatter link based on receiving the command from the source UE. In such examples, the source UE may determine a second decoding corresponding to an amount of time for decoding, by the reader UE, passive IoT data received from the passive IoT device based on the source UE transmitting the command. In the bi-static system, the source UE receives a message, from the reader UE, indicating the second decoding time. In a mono-static system, the source UE and the reader UE are the same UE. Therefore, in the mono-static system the same UE transmits the command to the passive IoT device and decodes the passive IoT device data received from the passive IoT device based on transmitting the command. In some examples, the source UE transmits, to a network node, a decoding time message indicating the first decoding time and the second decoding time. In such examples, the source UE receives, from the network node, a group of grants for communicating with the passive IoT device based on transmitting the decoding time message. The source UE may communicate with the passive IoT device based on receiving the group of grants. In the bi-static system, the source UE may transmit one or more grants of the group of grants to the reader UE, such that the reader UE may communicate with the passive IoT device based on the one or more grants.

Particular aspects of the subject matter described in this disclosure can be implemented to realize one or more of the following potential advantages. In some aspects, the described techniques can be used by a UE in a bi-static or mono-static system to receive one or more grants for communicating with a passive IoT device. In some such aspects, the one or more grants may facilitate communications between a UE, such as a one or both of a reader UE or a source UE, and the passive IoT device via a sidelink interface, a radio access interface (for example, Uu interface), or another type of wireless communication interface.

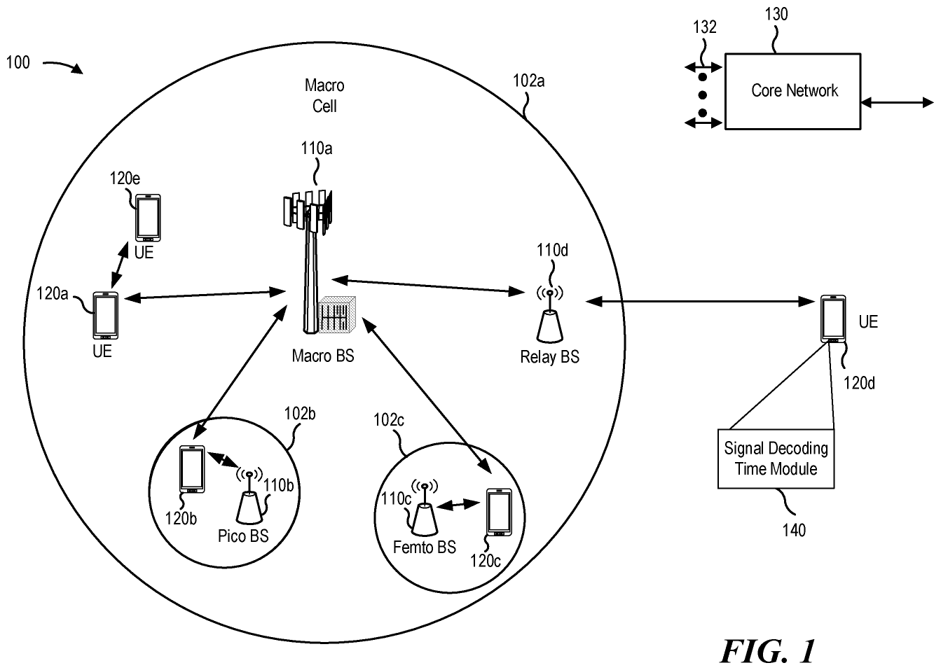

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (for example, macro BSs, pico BSs, femto BSs, relay BSs, and/or the like). These different types of BSs may have different transmit power levels, different coverage areas, and different impact on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

As an example, the BSs 110 (shown as BS 110a, BS 110b, BS 110c, and BS 110d) and the core network 130 may exchange communications via backhaul links 132 (for example, S1, etc.). Base stations 110 may communicate with one another over other backhaul links (for example, X2, etc.) either directly or indirectly (for example, through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (for example, S1, S2, etc.) and may perform radio configuration and scheduling for communications with the UEs 120. In some configurations, various functions of each access network entity or base station 110 may be distributed across various network devices (for example, radio heads and access network controllers) or consolidated into a single network device (for example, a base station 110).

UEs 120 (for example, 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example, a smart phone), a personal digital assistant (PDA), a wireless modem, a wireless communications device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

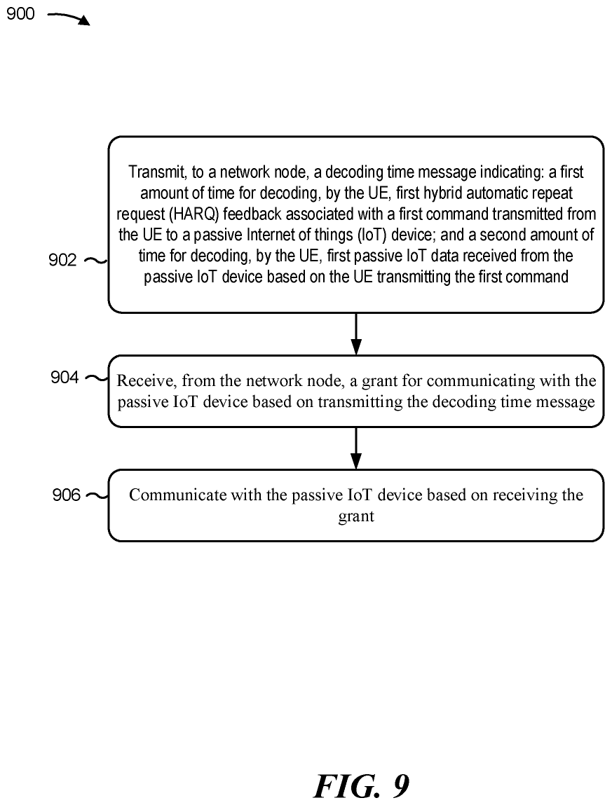

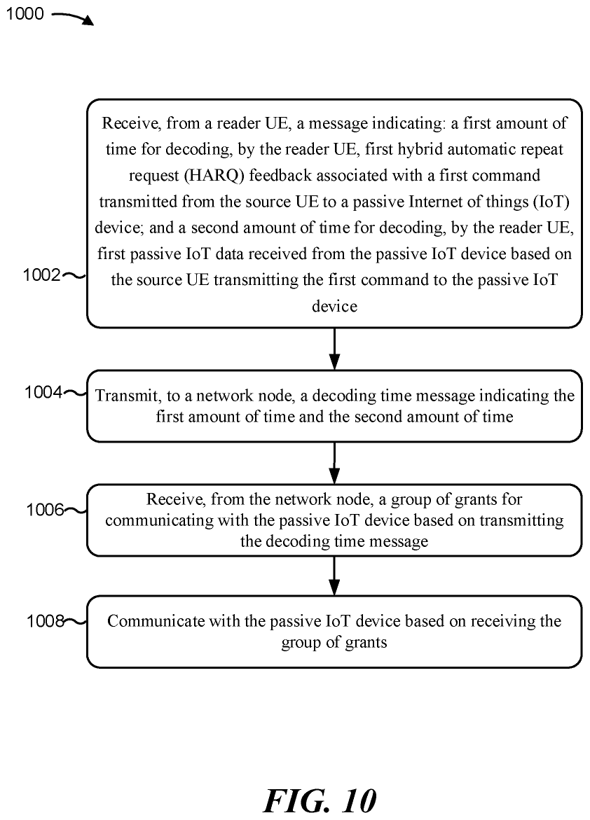

The UEs 120 may include a signal decoding time module 140. For brevity, only one UE 120d is shown as including the signal decoding time module 140. The signal decoding time module 140 may perform operations of the process 900 and 1000 described below with reference to FIGS. 9 and 10, respectively.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example, remote device), or some other entity. A wireless node may provide, for example, connectivity for or to a network (for example, a wide area network such as Internet or a cellular network) via a wired or wireless communications link. Some UEs may be considered Internet of things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

As indicated above, FIG. 1 is provided merely as an example. Other examples may differ from what is described with regard to FIG. 1.

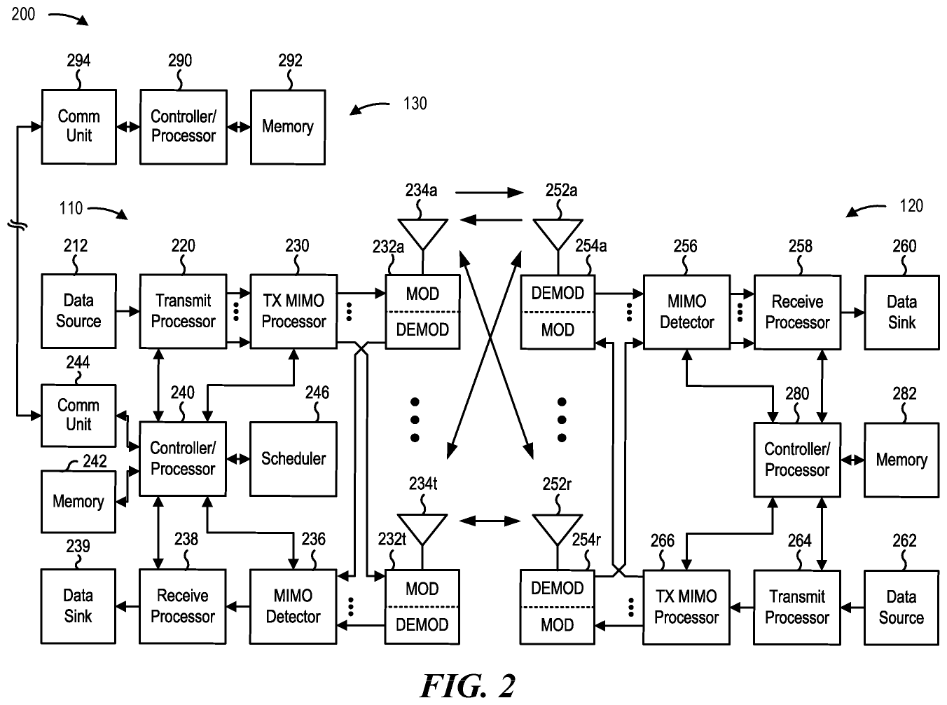

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for DFT-s-OFDM, CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with indicating decoding times for communications with a passive IoT device, as described in more detail elsewhere. For example, the controller/processor 240 of the base station 110, the controller/processor 280 of the UE 120, and/or any other component(s) of FIG. 2 may perform or direct operations of, for example, the processes of FIGS. 9 and 10 and/or other processes as described. Memories 242 and 282 may store data and program codes for the base station 110 and UE 120, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

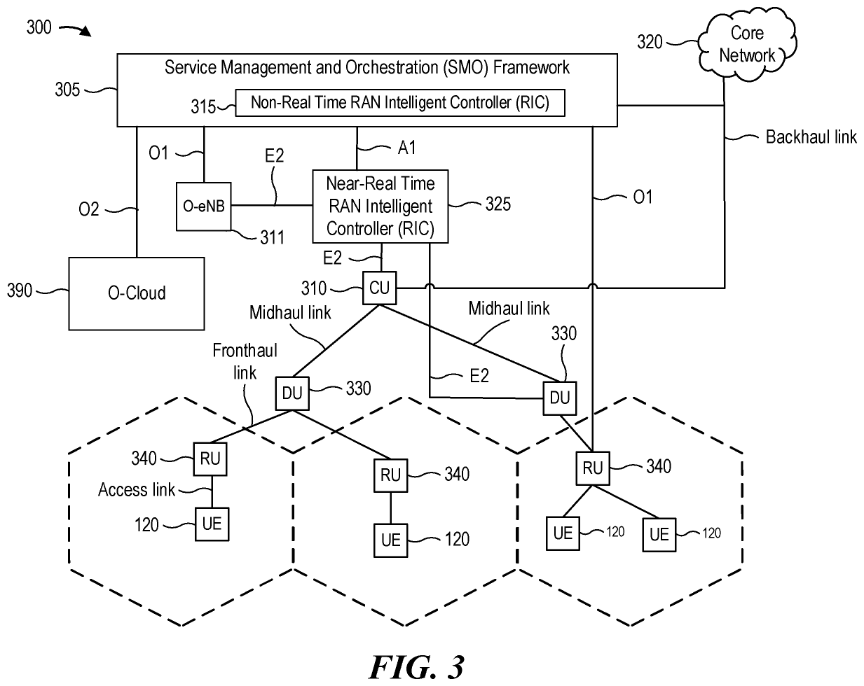

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO Framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via 01) or via creation of RAN management policies (such as A1 policies).

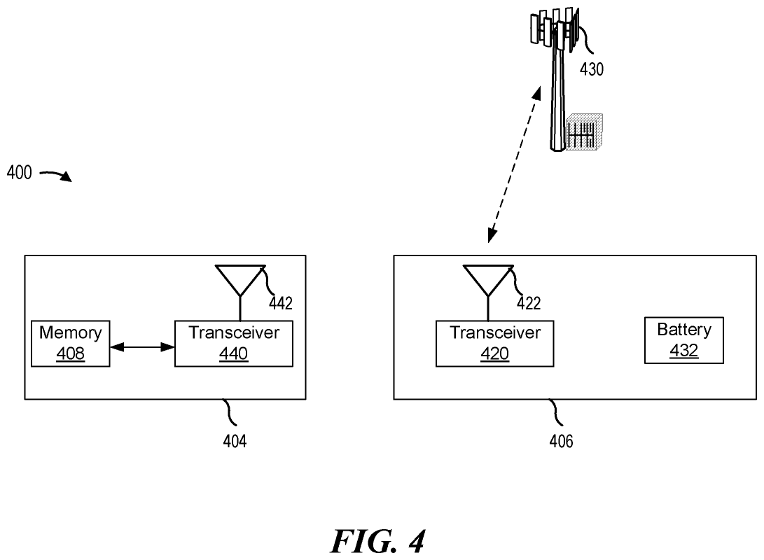

As discussed, IoT devices, such as RFID tags, may communicate with other devices via communication technologies. In most cases, an IoT device may be a passive IoT device or an active IoT device. In the passive IoT device, the tag (for example, an RFID tag) may be powered by external energy. Alternatively, in the active IoT device, the tag may be battery powered. FIG. 4 is a block diagram illustrating an example of a passive IoT system 400, in accordance with various aspects of the present disclosure. As shown in FIG. 4, a passive IT system 400 includes a passive IoT device 404 and a reader device 406. The passive IoT device 404 may have a memory 408 that stores data (for example, passive IoT data) associated with the passive IoT device 404. The passive IoT device 404 also includes a transmitter, a receiver, or a transmitter/receiver combination referred to as a transceiver 440 that transmits and receives signals from an antenna 442. The reader device 406 includes a transmitter, and a receiver, or a transceiver 420 that transmits and receives signals from an antenna 422. The reader device 406 may also communicate with a network node 430, such as a UE 120 or a base station 110 described with reference to FIGS. 1 and 2, a DU 330 described with reference to FIG. 3, a CU 310 described with reference to FIG. 3, or an RU 340 described with reference to FIG. 3. The reader device 406 may be powered by an external device, or it may be powered by an internal source such as a battery 432. In a passive system, the passive IoT device 404 may be powered by signal energy (for example, RF energy) transferred from the reader device 406. Based on receiving signal power from the reader device 406 or another device, the passive IoT device 404 transmits information stored in the memory 408 back to the reader device 406. The signal transmitted from the passive IoT device 404 may be an example of a reflection signal. In some examples, the transmission may be referred to as backscattering. By detecting the backscattering signal, the reader device 406 may identify the information stored in the memory 408 of the passive IoT device 404.

In most cases, active IoT tags tend to be larger and more expensive than passive tags because they contain more electronics due to the fact that they actively transmit data to a reader. In comparison, passive IoT tags are generally smaller because they draw power from the magnetic field generated between the passive tag itself and a reader to power its microchip's circuits, allowing information stored in the tag to be sent back to the reader. In general, passive IoT systems may be either short or long range. Passive IoT devices may also include storage that is read-only, read-write, or write once. Passive IoT devices may be less expensive, and smaller, than corresponding active IoT devices. Thus, passive IoT devices may be preferred when monitoring lower cost/value goods.

As discussed, the passive IoT device may reflect a signal to be received at a reader UE. The reflected signal may be an example of a backscattered signal. In some examples, the passive IoT device may use amplitude shift keying (ASK) to modulate the backscattered signal. ASK is an example of switching on the reflection when transmitting information bit ‘1’ and switching off the reflection when transmitting information bit ‘0’.

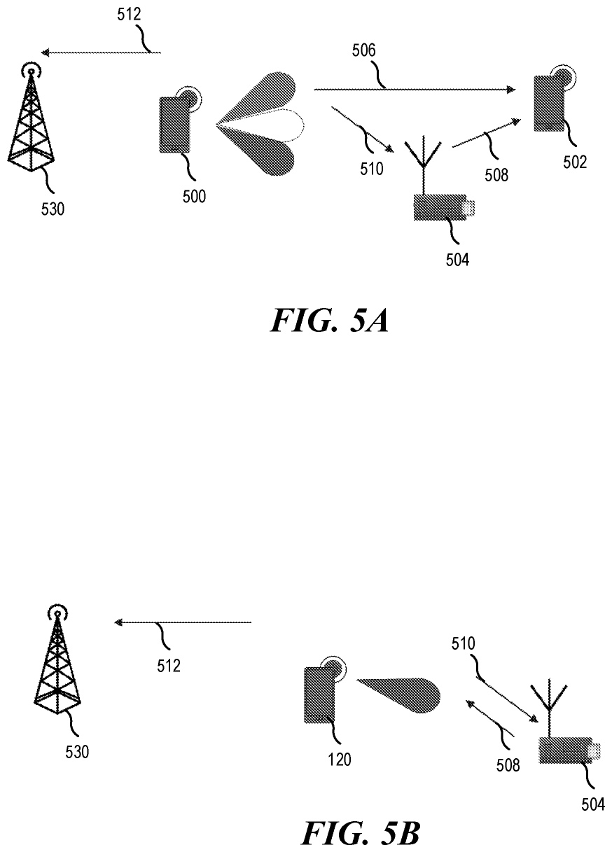

FIG. 5A is a diagram illustrating an example of a bi-static backscatter communication system, in accordance with various aspects of the present disclosure. In the example of FIG. 5A, a source UE 500 may transmit commands to a passive IoT device 504 via a forward link 510. The forward link 510 may be associated with a forward link impulse response h_{D1T}(n). Furthermore, the source UE 500 may communicate with a network node 530 via a first wireless interface 512, such as a Uu interface. The network node 530 may be an example of a base station 110 described with reference to FIGS. 1 and 2, a DU 330 described with reference to FIG. 3, a CU 310 described with reference to FIG. 3, or an RU 340 described with reference to FIG. 3. Additionally, a reader UE 502 may receive direct signals from the source UE 500 via a second wireless interface 506, such as a Uu interface, a sidelink interface, or another interface. The second wireless interface 506 may be associated with a wireless interface impulse response h_{D1D2}(n). The reader UE 502 may also receive a backscatter signal (for example, reflection signal) from the passive IoT device 504 via a backscatter link 508. The backscatter link 508 may be associated with a backscatter impulse response h_{TD2}(n). The source UE 500 and the reader UE 502 may be examples of a UE 120 described with reference to FIGS. 1, 2, and 3. The backscatter link may be a sidelink interface, a radio access interface (for example, Uu interface), or another type of interface, such as a new interface for communicating with the passive IoT device 504. In some examples, the network node 530 may transmit a message configuring the source UE 500 and the reader UE 502 to communicate with the passive IoT device 504 via a particular interface, such as the sidelink interface, the radio access interface, or another type of interface. The configuration may be based on UE preference, such as a power saving preference or a coverage preference. In some examples, the passive IoT device 504 is an IoT device that continuously uses an RFID-like radio, similar to a conventional RFID device. Alternatively, the passive IoT device 504 may be a device, such as a UE 120, that includes an RFID-like radio (for example, an additional radio) that may be used at certain time periods in order to conserve power.

In the example of FIG. 5A, the source UE 500 may transmit a radio wave x(n) to one or both of the reader UE 502 or the passive IoT device 504. Additionally, the passive IoT device 504 may transmit information bits s (n), where s(n)∈{0,1}. Based on the source UE 500 transmitting the radio wave x(n), the reader UE 502 may receive a signal y (n), where y (n)=(h_{D1D2}(n)+σ_{f}h_{D1T}(n)h_{TD2}(n)s(n))x(n)+noise). When s (n)=0, reflection may be disabled at the passive IoT device 504, such that the reader UE 502 only receives the direct signal via the second wireless interface 506. The direct signal may be represented as y (n)=h_{D1D2}(n)x(n)+noise. Alternatively, when s (n)=1, reflection may be enabled at the passive IoT device 504, such that the reader UE 502 receives a superposition of both the direct signal and backscatter signal. The superposition of the direct signal and backscatter signal may be represented as y(n)=(h_{D1D2}(n)+σ_{f}h_{D1T}(n)h_{TD2}(n)s(n))x(n)+noise), where the parameter σ_{f} denotes the reflection coefficient. In the example of FIG. 5A, the reader UE 502 may identify the information bit transmitted by the passive IoT device 504 by decoding the radio signal x(n) based on the known wireless interface impulse response h_{D1D2}(n). In such examples, the reader UE 502 may treat the backscatter signal as interference. The reader UE 502 may then detect the existence of the term σ_{f}h_{D1T}(n)h_{TD2}(n)s(n)x(n) by subtracting h_{D1D2}(n)x(n) from the received signal y(n).

The backscatter communication system discussed with reference to FIG. 5A is an example of a bi-static system. In such examples, the source UE and the reader UE are different UEs. In some other examples, the source UE and the reader UE may be the same UE. A mono-static system is an example of a system in which the source UE and the reader UE are the same UE.

FIG. 5B is a diagram illustrating an example of a mono-static backscatter communication system, in accordance with various aspects of the present disclosure. In the example of FIG. 5B, a UE 120 may include functionality associated with a source UE, such as the source UE 500 described with reference to FIG. 5A. Thus, as shown in FIG. 5B, the UE 120 may transmit commands to a passive IoT device 504 via a forward link 510. Furthermore, the UE 120 may communicate with a network node 530 via a wireless interface 512, such as a Uu interface. In the example of FIG. 5B, the UE 120 may also include functionality associated with a reader UE, such as the reader UE 502 described with reference to FIG. 5A. Therefore, the UE 120 may receive a backscatter signal (for example, a reflection signal) from the passive IoT device 504 via a backscatter link 508. The backscatter link 508 may be a sidelink interface, a radio access interface (for example, Uu interface), or another type of interface, such as a new interface.

In both a mono-static system and a bi-static system, a reader UE and a source UE may communicate with a passive IoT device based on one or more grants, such as a dynamic grant, configured by the network node. In some examples, the source UE may transmit commands to the passive IoT device based on receiving a grant from the network node. Additionally, or alternatively, the reader UE may receive data from the passive IoT device, via a backscattered signal, based on receiving a grant from the network node.

In some examples, the network node configures the one or more grants based on one or more decoding times associated with the reader UE. In such examples, a first decoding time of the one or more decoding times may correspond to an amount of time for decoding, by the reader UE, hybrid automatic repeat request (HARQ) feedback associated with a command transmitted from the source UE to the passive IoT device. The HARQ feedback may be an ACK or a NACK indicating whether the passive IoT device decoded the command (for example, information) transmitted from the source UE. The passive IoT device may transmit passive IoT data via the backscatter link based on receiving the command from the source UE. In some examples, a second decoding of the one or more decoding times may correspond to an amount of time for decoding, by the reader UE, passive IoT data received from the passive IoT device based on the source UE transmitting the command. The reader UE may generate an ACK or a NACK indicating whether the passive IoT device was decoded by the reader UE.

In some examples, for both the mono-static system and the bi-static system, a UE (for example, one or both of the reader UE or source UE) may indicate a capability of determining a decoding time and supporting such operations (for example, decoding operations) on one or more of a band, a bandwidth part, a frequency range, or a component carrier. Additionally, or alternatively, the UE may indicate support for operations on a combination of two or more of a band, a bandwidth part, a frequency range, or a component carrier. In some examples, the capability may be indicated via a message transmitted during initial access, such as msg1, msg3 in a four-step random access procedure, or msgA in a two-step random access procedure. In some other examples, the capability may be indicated via user-assistance information transmitted in an RRC message, or using an L1, L2, or L3 indication from the UE to the network node or from the UE to another UE. In some examples, timing capability may be associated with certain UE classes or types. In some such examples, the UE classes or types may be defined in a wireless standard (for example, 3GPP standard) or indicated via signaling from a network node. In some examples, the network node may transmit a capability inquiry message requesting the UE to inform the network node of its capability (for example, UECapabilityEnquiry). In such examples, the UE may indicate its capability (for example, UECapabilityInformation) based on receiving the capability inquiry message.

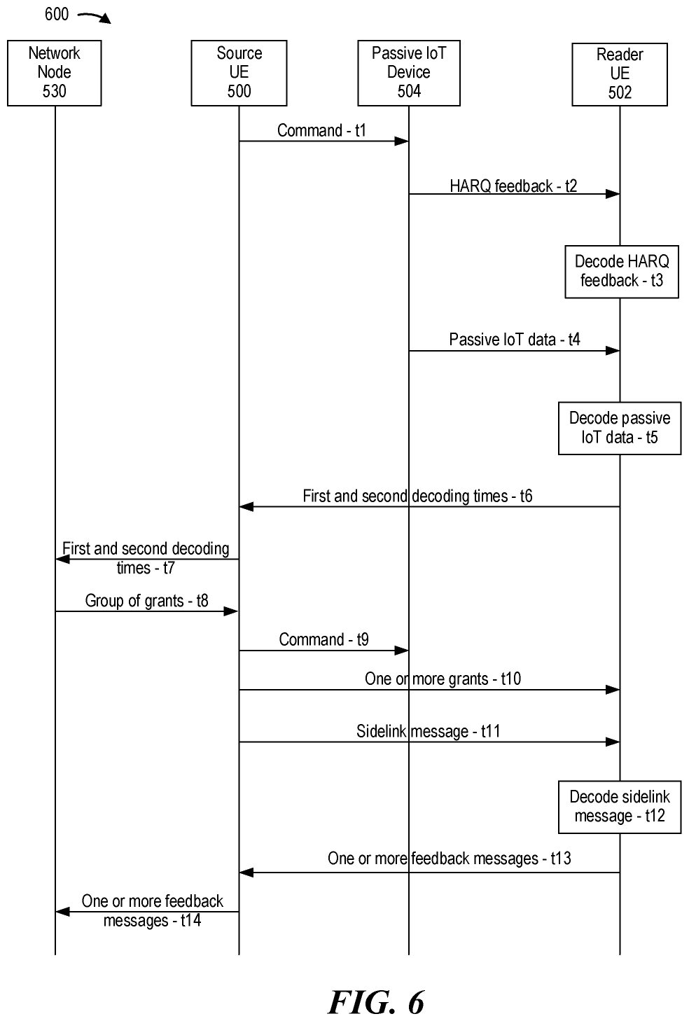

FIG. 6 is a timing diagram 600 illustrating an example of a source UE 500 in a bi-static system indicating one or more decoding times to a network node 530, in accordance with various aspects of the present disclosure. As shown in FIG. 6, at time t1, the source UE 500 transmits a command to a passive IoT device 504. The command may be transmitted to trigger transmission of passive IoT data from the passive IoT device 504. At time t2, the passive IoT device 504 may transmit HARQ feedback based on receiving the command at time t1. The HARQ feedback may be transmitted via a backscatter link. As shown in the example of FIG. 6, the HARQ feedback may be received at a reader UE 502. At time t3, the reader UE 502 decodes the HARQ feedback. An amount of time for decoding the HARQ feedback at time t3 may be referred to as a first decoding time. Additionally, at time t4, the passive IoT device 504 transmits the passive IoT data based on receiving the command at time t1. The passive IoT data may be transmitted via a backscatter link. The backscatter link may be a communication channel on a sidelink interface, a radio access interface (for example, Uu interface), or another type of interface. At time t5, the reader UE 502 decodes the passive IoT data. An amount of time for decoding the passive IoT data at time t5 may be referred to as a second decoding time.

In some examples, at time t6, the reader UE 502 may transmit a sidelink message to the source UE 500 indicating the first decoding time and the second decoding time. The sidelink message transmitted at time t6 may be transmitted via a sidelink channel, such as a physical sidelink shared channel (PSSCH). In some examples, a time for transmitting each of the first decoding time and the second decoding time may be based on a timing parameter, such as an N1 parameter or MinTimeGapPSFCH. In such examples, the first decoding time and the second decoding time may be indicated to the source UE 500 at different times. At time t7, the source UE 500 may transmit a decoding time message to the network node 530 indicating the first decoding time and the second decoding time. At time t8, the source UE 500 may receive a group of grants from the network node 530 for communicating with the passive IoT device 504 based on transmitting the decoding time message (for example, first and second decoding times) at time t7. Each grant of the group of grants may be transmitted at a different time instance. For ease of explanation, the example of FIG. 6 shows the group of grants being received at time t8. At time t9, the source UE 500 may transmit a command to the passive IoT device 504 based on one grant of the group of grants. Additionally, at time t10, the source UE 500 may transmit a message to the reader UE 502 indicating one or more grants from the group of grants. The reader UE 502 may communicate with the passive IoT device 504 based on receiving the one or more grants at time t10. The communication may include reading data (for example, passive IoT data) transmitted from the passive IoT device via a backscatter link. In some examples, the source UE 500 may transmit the one or more grants to the reader UE 502 after time t8 and before time t9.

Additionally, in some examples, at time t11, the source UE 500 may transmit a sidelink message to the reader UE 502 via a sidelink channel, such as a physical sidelink shared channel (PSSCH). Aspects of the present disclosure are not limited to the source UE 500 and the reader UE 502 communicating via the sidelink channel. Other types of channels or interfaces may be used. At time t12, the reader UE 502 may decode the sidelink message. The sidelink message transmission at time t11 and the decoding at time t12 may occur at any time at or before time t10. At time t13, the reader UE 502 transmits one or more feedback messages (for example, HARQ feedback messages) to the source UE 500. The feedback messages may be transmitted via a sidelink feedback channel, such as a physical sidelink feedback channel (PSFCH). The feedback messages may also be referred to as sidelink feedback messages. Each feedback message may indicate HARQ feedback. Specifically, each feedback message may be a one bit message indicating an ACK or a NACK. In some examples, the one or more feedback messages may include a first feedback message indicating the HARQ feedback transmitted by the passive IoT device 504 at time t2. The one or more feedback messages may also include a second feedback message indicating whether the passive IoT data was successfully decoded at time t5. The one or more feedback messages further include a third feedback message indicating whether the sidelink message was successfully decoded at time t12. Each of the one or more feedback messages may be transmitted to the source UE 500 at different time instances. For ease of explanation, the one or more feedback messages are shown as being transmitted at time t13. In some examples, each feedback message may be transmitted to the source UE 500 after a decoding event associated with the feedback message. In such examples, the first feedback message may be transmitted after receiving the HARQ feedback at time t2. Additionally, the second feedback message may be transmitted after decoding the passive IoT data at time t5. Furthermore, the third feedback message may be transmitted after decoding the sidelink message at time t12.

After receiving each of the one or more feedback messages, the reader UE 502 may transmit the one or more feedback messages to the network node 530 at time t14. As discussed, the one or more feedback messages may be received at the source UE 500 at different times due to the differences in processing times for each feedback message, as well as a time for relaying the message from the reader UE 502 to the source UE 500. Therefore, different transmission resources may be used to report the one or more feedback messages to the network node 530. The transmission resources may include one or both of time or frequency resources. In some examples, a timing for transmission of the one or more feedback message to the network node 530 may be governed by a timing parameter, such as sl-PSICH-ToPUCCH-CG-Type1-r16 and sl-PSFCH-TOPUCCH. For ease of explanation, the one or more feedback messages are shown as being transmitted at time t14. In some examples, each one of the first feedback message, the second feedback message, and the third feedback message are transmitted on a same group of physical uplink control channel (PUCCH) resources. In such examples, the first feedback message, the second feedback message, and the third feedback message may be multiplexed on the same group of PUCCH resources before encoding. In some such examples, the multiplexing may be performed on raw bits. For PUCCH format 0 a joint cyclic shift may be used. Alternatively, the bits may be concatenated as an input to a polar encoder for other PUCCH formats. In other examples, the first feedback message, the second feedback message, and the third feedback message may be multiplexed on the same group of PUCCH resources after encoding. In such examples, a mapping to resource elements may be predefined. In some other examples, for PUCCH format 0, a different cyclic shift may be applied to each one of the first feedback message, the second feedback message, and the third feedback message. In other examples, each one of the first feedback message, the second feedback message, and the third feedback message are transmitted on different PUCCH resources. In still some other examples, bit types of the passive IoT device 504 may be mapped to the same or different PUCCH resources.

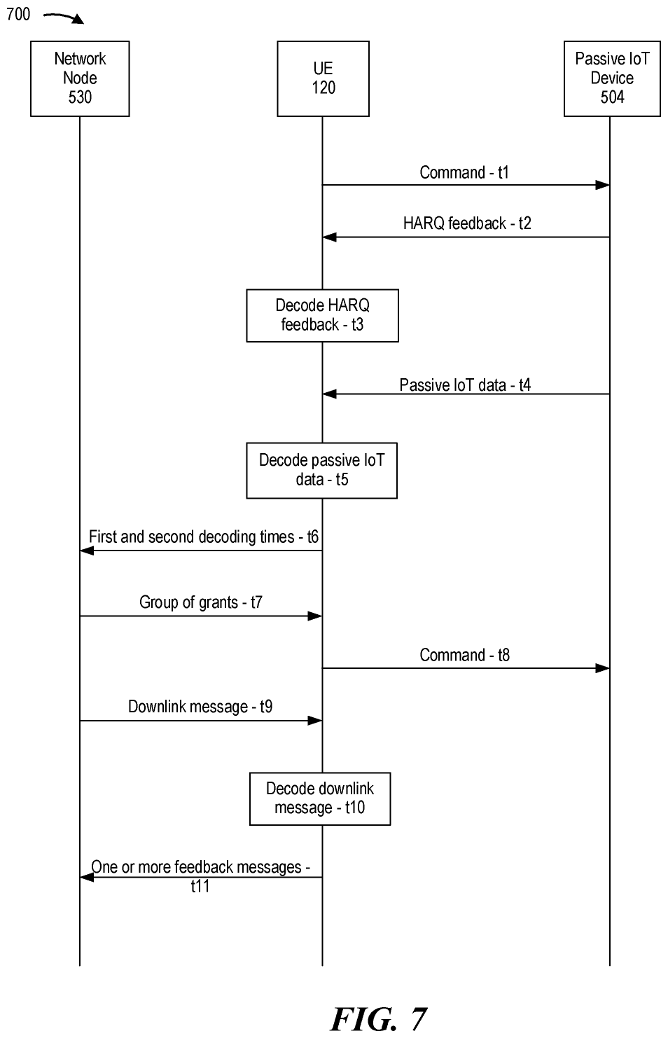

FIG. 7 is a timing diagram 700 illustrating an example of a UE 120 in a mono-static system indicating one or more decoding times to a network node 530, in accordance with various aspects of the present disclosure. As shown in FIG. 7, at time t1, the UE 120 transmits a command to a passive IoT device 504. The command may be transmitted to trigger transmission of passive IoT data from the passive IoT device 504. At time t2, the passive IoT device 504 may transmit HARQ feedback based on receiving the command at time t1. The HARQ feedback may be transmitted via a backscatter link. As shown in the example of FIG. 7, the HARQ feedback may be received at the UE 120. At time t3, the UE 120 decodes the HARQ feedback. An amount of time for decoding the HARQ feedback at time t3 may be referred to as a first decoding time. Additionally, at time t4, the passive IoT device 504 transmits the passive IoT data based on receiving the command at time t1. The passive IoT data may be transmitted via a backscatter link. The backscatter link may be a communication channel on a sidelink interface, a radio access interface (for example, Uu interface), or another type of interface. At time t5, the UE 120 decodes the passive IoT data. An amount of time for decoding the passive IoT data at time t5 may be referred to as a second decoding time.

At time t6, the UE 120 may transmit a decoding time message to the network node 530 indicating the first decoding time and the second decoding time. At time t7, the source UE 500 may receive a group of grants from the network node 530 for communicating with the passive IoT device 504 based on transmitting the decoding time message (for example, first and second decoding times) at time t6. Each grant of the group of grants may be transmitted at a different time instance. For ease of explanation, the example of FIG. 7 shows the group of grants being received at time t7. The UE 120 may communicate with the passive IoT device 504 based on receiving the one or more grants at time t7. The communication may include reading data (for example, passive IoT data) transmitted from the passive IoT device 504 via a backscatter link and transmitting commands to the passive IoT device 504 via a forward link. At time t8, the source UE 500 may transmit a command to the passive IoT device 504 based on one grant of the group of grants.

Additionally, in some examples, at time t9, the UE 120 may receive a downlink message from the network node 530. The downlink message may be received via a downlink channel, such as a physical downlink shared channel (PDSCH), physical downlink control channel (PDCCH), or another type of channel (for example, sidelink channel). At time t10, the UE 120 may decode the downlink message. In some examples, the sidelink message transmission at time t9 and the decoding at time t10 may occur at any time at or before time t8.

As shown in FIG. 7, at time t11, the UE 120 may transmit one or more feedback messages to the network node 530. A timing of the transmissions at time t7 and t11 associated with passive IoT data may be based on a timing parameter, such as N1_tag or MinTimeGapPSFCH_tag. This timing parameter may be used instead of conventional parameters, such as MinTimeGapPSICH, sl-PSFCH-ToPUCCH-CG-Type1-r16, and sl-PSFCH-ToPUCCH. In some examples, sl-PSICH-ToPUCCH and sl-PSFCH-ToPUCCH-CG-Type1-r16 may be used for a timing of the feedback messages (for example, the third feedback message) associated with decoding downlink messages received at the UE 120. Each feedback message may indicate HARQ feedback. Specifically, each feedback message may be a one bit message indicating an ACK or a NACK. In some examples, the one or more feedback messages may include a first feedback message indicating the HARQ feedback transmitted by the passive IoT device 504 at time t2. The one or more feedback messages may also include a second feedback message indicating whether the passive IoT data was successfully decoded at time t5. The one or more feedback messages further include a third feedback message indicating whether the downlink message was successfully decoded at time t10. As discussed, the one or more feedback messages may be received at the source UE 500 at different times due to the differences in processing times for each feedback message, as well as a time for relaying the message from the reader UE 502 to the source UE 500. Therefore, different transmission resources may be used to report the one or more feedback messages to the network node. The transmission resources may include one or both of time or frequency resources. Still, for ease of explanation, the one or more feedback messages are shown as being transmitted at time t11. In some examples, each feedback message may be transmitted to the network node 530 after a decoding event associated with the feedback message. In such examples, the first feedback message may be transmitted after receiving the HARQ feedback at time t2. Additionally, the second feedback message may be transmitted after decoding the passive IoT data at time t5. Furthermore, the third feedback message may be transmitted after decoding the downlink message at time t10.

In some examples, each one of the first feedback message, the second feedback message, and the third feedback message are transmitted on a same group of PUCCH resources. In such examples, the first feedback message, the second feedback message, and the third feedback message may be multiplexed on the same group of PUCCH resources before encoding. In some such examples, the multiplexing may be performed on raw bits. For PUCCH format 0 a joint cyclic shift may be used. Alternatively, the bits may be concatenated as an input to a polar encoder for other PUCCH formats. In other examples, the first feedback message, the second feedback message, and the third feedback message may be multiplexed on the same group of PUCCH resources after encoding. In such examples, a mapping to resource elements may be predefined. In some other examples, for PUCCH format 0, a different cyclic shift may be applied to each one of the first feedback message, the second feedback message, and the third feedback message. In other examples, each one of the first feedback message, the second feedback message, and the third feedback message are transmitted on different PUCCH resources. In still some other examples, bit types of the passive IoT device 504 may be mapped to the same or different PUCCH resources.

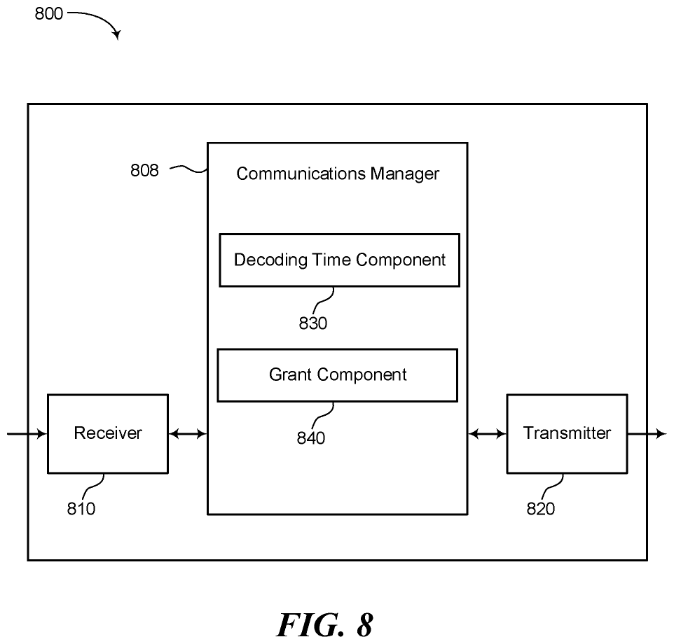

FIG. 8 is a block diagram illustrating an example wireless communication device that supports communicating with a passive IoT device, in accordance with some aspects of the present disclosure. The device 800 may be an example of aspects of a UE 120 described with reference to FIGS. 1, 2, 5B, and 7, or a reader UE 502 described with reference to FIGS. 5A and 6. The wireless communications device 800 may include a receiver 810, a communications manager 808, a transmitter 820, a decoding time component 830, and a grant component 840, which may be in communication with one another (for example, via one or more buses). In some examples, the wireless communications device 800 is configured to perform operations, including operations of the process 900 and 1000 described below with reference to FIGS. 9 and 10, respectively.

In some examples, the wireless communications device 800 can include a chip, chipset, package, or device that includes at least one processor and at least one modem (for example, a 5G modem or other cellular modem). In some examples, the communications manager 808, or its sub-components, may be separate and distinct components. In some examples, at least some components of the communications manager 808 are implemented at least in part as software stored in a memory. For example, portions of one or more of the components of the communications manager 808 can be implemented as non-transitory code executable by the processor to perform the functions or operations of the respective component.

The receiver 810 may receive one or more of reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communications devices via various channels including control channels (for example, a physical downlink control channel (PDCCH), physical uplink control channel (PUCCH), or physical sidelink control channel (PSCCH) and data channels (for example, a physical downlink shared channel (PDSCH), physical sidelink shared channel (PSSCH), a physical uplink shared channel (PUSCH)). The other wireless communications devices may include, but are not limited to, a base station 110 described with reference to FIGS. 1 and 2, a DU 330 described with reference to FIG. 3, a CU 310 described with reference to FIG. 3, an RU 340 described with reference to FIG. 3, or a network node 530 described with reference to FIGS. 5A, 5B, 6, and 7.

The received information may be passed on to other components of the device 800. The receiver 810 may be an example of aspects of the receive processor 256 described with reference to FIG. 2. The receiver 810 may include a set of radio frequency (RF) chains that are coupled with or otherwise utilize a set of antennas (for example, the set of antennas may be an example of aspects of the antennas 252 described with reference to FIG. 2).

The transmitter 820 may transmit signals generated by the communications manager 808 or other components of the wireless communications device 800. In some examples, the transmitter 820 may be collocated with the receiver 810 in a transceiver. The transmitter 820 may be an example of aspects of the transmit processor 268 described with reference to FIG. 2. The transmitter 820 may be coupled with or otherwise utilize a set of antennas (for example, the set of antennas may be an example of aspects of the antennas 252 described with reference to FIG. 2), which may be antenna elements shared with the receiver 810. In some examples, the transmitter 820 is configured to transmit control information in a PUCCH, PSCCH, or PDCCH and data in a physical uplink shared channel (PUSCH), PSSCH, or PDSCH.

The communications manager 808 may be an example of aspects of the controller/processor 259 described with reference to FIG. 2. The communications manager 808 may include the decoding time component 830 and the grant component 840. In some examples, working in conjunction with the transmitter 820, the decoding time component 830 transmits, to a network node, a decoding time message indicating: a first amount of time for decoding, by the UE, first HARQ feedback associated with a first command transmitted from the UE to a passive IoT device; and a second amount of time for decoding, by the UE, first passive IoT data received from the passive IoT device based on the UE transmitting the first command. Additionally, in such examples, working in conjunction with the receiver 810, the grant component 830 may receive, from the network node, a grant for communicating with the passive IoT device based on transmitting the decoding time message. Furthermore, working in conjunction with one or more of the decoding time component 830, the grant component 840, or the transmitter 810, the communications manager 808 communicates with the passive IoT device based on receiving the grant.

In some other examples, working in conjunction with the receiver 810, the decoding time component 830 receives, from a reader UE, a message indicating: a first amount of time for decoding, by the reader UE, first HARQ feedback associated with a first command transmitted from the source UE to a passive IoT device; and a second amount of time for decoding, by the reader UE, first passive IoT data received from the passive IoT device based on the source UE transmitting the first command to the passive IoT device. In such examples, working in conjunction with the transmitter 810, the decoding time component 830 may transmit, to a network node, a decoding time message indicating the first amount of time and the second amount of time. Additionally, in such examples, working in conjunction with the receiver 810, the grant component 830 may receive, from the network node, a group of grants for communicating with the passive IoT device based on transmitting the decoding time message. Furthermore, working in conjunction with one or more of the decoding time component 830, the grant component 840, or the transmitter 810, the communications manager 808 communicates with the passive IoT device based on receiving the group of grants.

FIG. 9 is a flow diagram illustrating an example process 900 performed by a UE, in accordance with some aspects of the present disclosure. The UE may be an example of a UE 120 described with reference to 1, 2, 5B, and 7. The example process 900 is an example of receiving a grant for communicating with a passive IoT device based on a decoding time of the UE. As shown in FIG. 9, the process 900 begins at block 902 by transmitting, to a network node, a decoding time message indicating: a first amount of time for decoding, by the UE, first HARQ feedback associated with a first command transmitted from the UE to a passive IoT device; and a second amount of time for decoding, by the UE, first passive IoT data received from the passive IoT device based on the UE transmitting the first command. In some examples, the first HARQ feedback and the first passive IoT data may be received via a backscattered transmission from the passive IoT device. At block 904, the process 900 receives a grant for communicating with the passive IoT device based on transmitting the decoding time message. At block 906, the process 900 communicates with the passive IoT device based on receiving the grant. In some examples, the UE communicates with the passive IoT device via a sidelink interface or a radio access interface. The passive IoT device may be an example of an RFID tag.

FIG. 10 is a flow diagram illustrating an example process 1000 performed by a UE, in accordance with some aspects of the present disclosure. The UE may be an example of a source UE 500 described with reference to FIGS. 5A and 6. The example process 1000 is an example of receiving a grant for communicating with a passive IoT device based on a decoding time of a reader UE. As shown in FIG. 10, the process 1000 begins at block 1002 by receiving, from a reader UE, a message indicating: a first amount of time for decoding, by the reader UE, first HARQ feedback associated with a first command transmitted from the source UE to a passive IoT device; and a second amount of time for decoding, by the reader UE, first passive IoT data received from the passive IoT device based on the source UE transmitting the first command to the passive IoT device. In some examples, the first HARQ feedback and the first passive IoT data may be received via a backscattered transmission from the passive IoT device. At block 1004, the process 1000 transmits, to a network node, a decoding time message indicating the first amount of time and the second amount of time. At block 1006, the process 1000 receives, from the network node, a group of grants for communicating with the passive IoT device based on transmitting the decoding time message. At block 1008, the process 1000 communicates with the passive IoT device based on receiving the group of grants. In some examples, the reader UE and the source UE communicate with the passive IoT device via a sidelink interface or a radio access interface. The passive IoT device may be an example of an RFID tag.

Implementation examples are described in the following numbered clauses:

Clause 1. A method for wireless communication performed at a UE, comprising: transmitting, to a network node, a decoding time message indicating: a first amount of time for decoding, by the UE, first HARQ feedback associated with a first command transmitted from the UE to a passive IoT device; and a second amount of time for decoding, by the UE, first passive IoT data received from the passive IoT device based on the UE transmitting the first command; receiving a grant for communicating with the passive IoT device based on transmitting the decoding time message; and communicating with the passive IoT device based on receiving the grant.

Clause 2. The method of Clause 1, further comprising receiving the first HARQ feedback and the first passive IoT data via a backscattered transmission from the passive IoT device.

Clause 3. The method of any one of Clauses 1-2, further comprising transmitting, to the network node, a first HARQ message indicating the first HARQ feedback, and a second HARQ message indicating second HARQ feedback associated with decoding the first passive IoT data.

Clause 4. The method of any one of Clauses 1-3, further comprising: receiving, from the network node, a downlink message; decoding the downlink message; and transmitting a third HARQ message indicating third HARQ feedback associated with decoding the downlink message.

Clause 5. The method of Clause 4, wherein each one of the first HARQ message, the second HARQ message, and the third HARQ message are transmitted at different time instances.

Clause 6. The method of Clause 5, wherein each one of the first HARQ message, the second HARQ message, and the third HARQ message are transmitted on a same group of PUCCH resources.

Clause 7. The method of Clause 6, wherein: the first HARQ message, the second HARQ message, and the third HARQ message are multiplexed on the same group of PUCCH resources after encoding; the first HARQ message, the second HARQ message, and the third HARQ message are multiplexed on the same group of PUCCH resources before encoding; or a different cyclic shift is applied to each one of the first HARQ message, the second HARQ message, and the third HARQ message.

Clause 8. The method of Clause 5, wherein each one of the first HARQ message, the second HARQ message, and the third HARQ message are transmitted on different PUCCH resources.

Clause 9. The method of any one of Clause 1-8, wherein communicating with the passive IoT device includes transmitting a second command to the passive IoT device and receiving second passive IoT data from the passive IoT device based on transmitting the second command.

Clause 10. The method of any one of Clauses 1-9, wherein the UE communicates with the passive IoT device via a sidelink interface or a radio access interface.

Clause 11. The method of any one of Clauses 1-11, wherein the passive IoT device is an RFID tag.

Clause 12. A method for wireless communication performed at a source UE, comprising: receiving, from a reader UE, a message indicating: a first amount of time for decoding, by the reader UE, first HARQ feedback associated with a first command transmitted from the source UE to a passive IoT device; and a second amount of time for decoding, by the reader UE, first passive IoT data received from the passive IoT device based on the source UE transmitting the first command to the passive IoT device; transmitting, to a network node, a decoding time message indicating the first amount of time and the second amount of time; receiving a group of grants for communicating with the passive IoT device based on transmitting the decoding time message; and communicating with the passive IoT device based on receiving the group of grants.

Clause 13. The method of Clause 12, wherein communicating with the passive IoT device includes transmitting a second command to the passive IoT device.

Clause 14. The method of any one of Clauses 12-13, further comprising transmitting, to the reader UE, one or more grants from the group of grants, wherein the reader UE receives second passive IoT data from the passive IoT device based on the one or more grants.

Clause 15. The method of any one of Clauses 12-14, further comprising: receiving, from the reader UE, a first feedback message indicating the first HARQ feedback, and a second feedback message indicating second HARQ feedback associated with decoding the first passive IoT data; and transmitting, to the network node, a first HARQ message indicating the first HARQ feedback and a second HARQ message indicating the second HARQ feedback.

Clause 16. The method of any one of Clauses 12-15, further comprising: transmitting a sidelink message to the reader UE; receiving, from the reader UE, a third feedback message indicating third HARQ feedback associated with decoding the sidelink message; and transmitting, to the network node, a third HARQ message indicating the third HARQ feedback.

Clause 17. The method of Clause 16, wherein each one of the first HARQ message, the second HARQ message, and the third HARQ message are transmitted at different time instances.

Clause 18. The method of Clause 17, wherein each one of the first HARQ message, the second HARQ message, and the third HARQ message are transmitted on a same group of PUCCH resources.

Clause 19. The method of Clause 18, wherein: the first HARQ message, the second HARQ message, and the third HARQ message are multiplexed on the same group of PUCCH resources after encoding; the first HARQ message, the second HARQ message, and the third HARQ message are multiplexed on the same group of PUCCH resources before encoding; or a different cyclic shift is applied to each one of the first HARQ message, the second HARQ message, and the third HARQ message.

Clause 20. The method of Clause 17, wherein each one of the first HARQ message, the second HARQ message, and the third HARQ message are transmitted on different PUCCH resources.

Clause 21. The method of any one of Clauses 12-20, wherein the source UE communicates with the passive IoT device via a sidelink interface or a radio access interface.

Clause 22. The method of any one of Clauses 12-21, wherein the passive IoT device is an RFID tag.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication performed at a user equipment (UE), comprising:
transmitting, to a network node, a decoding time message indicating:
a first amount of time for decoding, by the UE, first hybrid automatic repeat request (HARQ) feedback associated with a first command transmitted from the UE to a passive Internet of things (IoT) device; and
a second amount of time for decoding, by the UE, first passive IoT data received from the passive IoT device based on the UE transmitting the first command;
receiving, from the network node, a grant for communicating with the passive IoT device based on transmitting the decoding time message; and
communicating with the passive IoT device based on receiving the grant.

2. The method of claim 1, further comprising receiving the first HARQ feedback and the first passive IoT data via a backscattered transmission from the passive IoT device.

3. The method of claim 1, further comprising transmitting, to the network node, a first HARQ message indicating the first HARQ feedback, and a second HARQ message indicating second HARQ feedback associated with decoding the first passive IoT data.

4. The method of claim 3, further comprising:
receiving, from the network node, a downlink message;
decoding the downlink message; and
transmitting a third HARQ message indicating third HARQ feedback associated with decoding the downlink message.

5. The method of claim 4, wherein each one of the first HARQ message, the second HARQ message, and the third HARQ message are transmitted at different time instances.

6. The method of claim 5, wherein each one of the first HARQ message, the second HARQ message, and the third HARQ message are transmitted on a same group of physical uplink control channel (PUCCH) resources.

7. The method of claim 6, wherein:
the first HARQ message, the second HARQ message, and the third HARQ message are multiplexed on the same group of PUCCH resources after encoding;
the first HARQ message, the second HARQ message, and the third HARQ message are multiplexed on the same group of PUCCH resources before encoding; or
a different cyclic shift is applied to each one of the first HARQ message, the second HARQ message, and the third HARQ message.

8. The method of claim 5, wherein each one of the first HARQ message, the second HARQ message, and the third HARQ message are transmitted on different physical uplink control channel (PUCCH) resources.

9. The method of claim 5, wherein communicating with the passive IoT device includes transmitting a second command to the passive IoT device and receiving second passive IoT data from the passive IoT device based on transmitting the second command.

10. The method of claim 1, wherein the UE communicates with the passive IoT device via a sidelink interface or a radio access (Uu) interface.

11. The method of claim 1, wherein the passive IoT device is a radio frequency identification (RFID) tag.

12. An apparatus for wireless communications at a user equipment (UE), comprising:
a processor; and
a memory coupled with the processor and storing instructions operable, when executed by the processor, to cause the apparatus to:
transmit, to a network node, a decoding time message indicating:
a first amount of time for decoding, by the UE, first hybrid automatic repeat request (HARQ) feedback associated with a first command transmitted from the UE to a passive Internet of things (IoT) device; and
a second amount of time for decoding, by the UE, first passive IoT data received from the passive IoT device based on the UE transmitting the first command;
receive, from the network node, a grant for communicating with the passive IoT device based on transmitting the decoding time message; and
communicate with the passive IoT device based on receiving the grant.

13. The apparatus of claim 12, wherein execution of the instructions further cause the apparatus to receive the first HARQ feedback and the first passive IoT data via a backscattered transmission from the passive IoT device.

14. The apparatus of claim 12, wherein execution of the instructions further cause the apparatus to transmit, to the network node, a first HARQ message indicating the first HARQ feedback, and a second HARQ message indicating second HARQ feedback associated with decoding the first passive IoT data.

15. The apparatus of claim 12, wherein the UE communicates with the passive IoT device via a sidelink interface or a radio access (Uu) interface.

16. A method for wireless communication performed at a source user equipment (UE), comprising:
receiving, from a reader UE, a message indicating:
a first amount of time for decoding, by the reader UE, first hybrid automatic repeat request (HARQ) feedback associated with a first command transmitted from the source UE to a passive Internet of things (IoT) device; and
a second amount of time for decoding, by the reader UE, first passive IoT data received from the passive IoT device based on the source UE transmitting the first command to the passive IoT device;
transmitting, to a network node, a decoding time message indicating the first amount of time and the second amount of time;
receiving, from the network node, a group of grants for communicating with the passive IoT device based on transmitting the decoding time message; and
communicating with the passive IoT device based on receiving the group of grants.

17. The method of claim 16, wherein communicating with the passive IoT device includes transmitting a second command to the passive IoT device.

18. The method of claim 16, further comprising transmitting, to the reader UE, one or more grants from the group of grants,
wherein the reader UE receives second passive IoT data from the passive IoT device based on the one or more grants.

19. The method of claim 16, further comprising:
receiving, from the reader UE, a first feedback message indicating the first HARQ feedback, and a second feedback message indicating second HARQ feedback associated with decoding the first passive IoT data; and
transmitting, to the network node, a first HARQ message indicating the first HARQ feedback and a second HARQ message indicating the second HARQ feedback.

20. The method of claim 19, further comprising:
transmitting a sidelink message to the reader UE;
receiving, from the reader UE, a third feedback message indicating third HARQ feedback associated with decoding the sidelink message; and
transmitting, to the network node, a third HARQ message indicating the third HARQ feedback.

21. The method of claim 20, wherein each one of the first HARQ message, the second HARQ message, and the third HARQ message are transmitted at different time instances.

22. The method of claim 21, wherein each one of the first HARQ message, the second HARQ message, and the third HARQ message are transmitted on a same group of physical uplink control channel (PUCCH) resources.

23. The method of claim 22, wherein:
the first HARQ message, the second HARQ message, and the third HARQ message are multiplexed on the same group of PUCCH resources after encoding;
the first HARQ message, the second HARQ message, and the third HARQ message are multiplexed on the same group of PUCCH resources before encoding; or
a different cyclic shift is applied to each one of the first HARQ message, the second HARQ message, and the third HARQ message.

24. The method of claim 21, wherein each one of the first HARQ message, the second HARQ message, and the third HARQ message are transmitted on different physical uplink control channel (PUCCH) resources.

25. The method of claim 16, wherein the source UE communicates with the passive IoT device via a sidelink interface or a radio access (Uu) interface.

26. The method of claim 16, wherein the passive IoT device is a radio frequency identification (RFID) tag.

27. An apparatus for wireless communications at a user equipment (UE), comprising:
a processor; and
a memory coupled with the processor and storing instructions operable, when executed by the processor, to cause the apparatus to:
receive, from a reader UE, a message indicating:
a first amount of time for decoding, by the reader UE, first hybrid automatic repeat request (HARQ) feedback associated with a first command transmitted from the source UE to a passive Internet of things (IoT) device; and
a second amount of time for decoding, by the reader UE, first passive IoT data received from the passive IoT device based on the source UE transmitting the first command to the passive IoT device;
transmit, to a network node, a decoding time message indicating the first amount of time and the second amount of time;
receive, from the network node, a group of grants for communicating with the passive IoT device based on transmitting the decoding time message; and
communicate with the passive IoT device based on receiving the group of grants.

28. The apparatus of claim 27, wherein execution of the instructions further cause the apparatus to transmit, to the reader UE, one or more grants from the group of grants, wherein the reader UE receives second passive IoT data from the passive IoT device based on the one or more grants.

29. The apparatus of claim 27, wherein execution of the instructions further cause the apparatus to:
receive, from the reader UE, a first feedback message indicating the first HARQ feedback, and a second feedback message indicating second HARQ feedback associated with decoding the first passive IoT data; and
transmit, to the network node, a first HARQ message indicating the first HARQ feedback and a second HARQ message indicating the second HARQ feedback.

30. The apparatus of claim 27, wherein the source UE communicates with the passive IoT device via a sidelink interface or a radio access (Uu) interface.
